(19) United States
(12) Patent Application Publication
(10) Pub. No.: US 2026/0312927 A1
(43) Pub. Date: Oct. 8, 2026

(54) RISK-BASED EVENT PREDICTION AND ALERT WITH VISUALIZED PROCESS FLOW

(71) Applicant: INTERNATIONAL BUSINESS MACHINES CORPORATION, Armonk, NY (US)

(72) Inventors: Ying Li, Shanghai (CN); Wen Juan Nie, Ningbo (CN); Jiong Lu, Shanghai (CN); Xiao Xia Mao, Shanghai (CN); Danlei Zhang, Shanghai (CN); Yi Chen Zhang, Shanghai (CN)

(21) Appl. No.: 19/169,506

(22) Filed: Apr. 3, 2025

(51) Int. Cl. H04L 51/216; G06F 9/451

(52) U.S. Cl. CPC H04L 51/216; G06F 9/451

(57) ABSTRACT

A messaging tool is executed to conduct and analyze a real-time conversation between, at least, one user and another user. The messaging tool includes at least one artificial intelligence model generated and integrated into the messaging tool. The at least one artificial intelligence model is generated based on analyzing historical data including data related to, at least, one or more historical risk-based events. The at least one artificial intelligence model is trained to categorize analysis data resulting from the analyzing the historical data and to predict a risk-based event. Real-time analysis is performed of the real-time conversation to generate a probability score. The probability score indicates a prediction that the real-time conversation is the risk-based event. The risk-based event is visualized to indicate to a selected user that the real-time conversation is the risk-based event. The selected user is a user of the real-time conversation.

### BACKGROUND

One or more aspects relate, in general, to processing within computing environments, including telecommunications networks, and in particular, to improving such processing as it relates to risk-based events occurring within such environments.

Telecommunications networks are used for communication and data transmission. As an example, telecommunications networks are used for conversations between users that employ telephones, mobile phones, laptops, computers, tablets, wearable devices and/or other devices. The conversations may use voice, written, audio and/or video communications, as well as other types of communications.

During the conversations, certain information may be exchanged that indicates one or more risk-based events. Risk-based events are events that have inherent and/or intentional risks associated therewith. These types of events have evolved over many years into diverse and sophisticated forms, particularly with the emergence of artificial intelligence.

While some platforms and applications warn users against potential risk-based events, users may ignore the notifications, especially when in certain circumstances.

### SUMMARY

Shortcomings of the prior art are overcome, and additional advantages are provided through the provision of a method. The method includes executing a messaging tool on a computing device to conduct and analyze a real-time conversation between, at least, one user and another user. The messaging tool includes at least one artificial intelligence model generated and integrated into the messaging tool. The at least one artificial intelligence model is generated based on analyzing historical data obtained from one or more exogenous sources. The historical data includes, at least, data related to one or more historical risk-based events. The at least one artificial intelligence model is trained to categorize analysis data resulting from the analyzing the historical data and to predict a risk-based event. Real-time analysis is performed, using the messaging tool, of the real-time conversation to generate a probability score. The probability score indicates a prediction that the real-time conversation is the risk-based event. The risk-based event is visualized using the messaging tool to indicate to a selected user that the real-time conversation is the risk-based event. The selected user is a user of the one user and the other user of the real-time conversation.

Computer systems and computer program products relating to one or more aspects are also described and may be claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present disclosure;

FIG. 2 depicts one example of the risk-based event prediction and alert code of FIG. 1, in accordance with one or more aspects of the present disclosure;

FIG. 3 depicts one example of a risk-based event prediction and alert process that uses the risk-based event prediction and alert code of FIG. 2, in accordance with one or more aspects of the present disclosure;

FIG. 4A depicts one example of a category model used in accordance with one or more aspects of the present disclosure;

FIG. 4B depicts one example of a prediction model used in accordance with one or more aspects of the present disclosure;

FIG. 4C depicts one example of a visualized process flow, in accordance with one or more aspects of the present disclosure;

FIG. 5 depicts one example of a messaging tool used in accordance with one or more aspects of the present disclosure;

FIG. 6 depicts one example of a messaging tool process that uses the risk-based event prediction and alert code of FIG. 2, in accordance with one or more aspects of the present disclosure; and

FIG. 7 depicts one example of a machine learning training system used in accordance with one or more aspects of the present disclosure.

### DETAILED DESCRIPTION

In one or more aspects, a capability is provided to facilitate processing within a computing environment. In one or more aspects, a capability is provided to facilitate processing within a telecommunications network that is susceptible to risk-based events. One or more aspects use a combination of language and linguistic tactics historically used in risk-based events and the relationships and conversation sequences between users (e.g., a conversation sender and receiver) to predict a risk-based event and the patterns of risk-based events in real-time. Further, in one or more aspects, visualization is employed to assist users in obtaining alerts relating to risk-based events in the conversations or blocking users to avoid a risk-based event.

A conversation, as used herein, includes communications between a plurality of users (e.g., human and/or non-human, such as a device, robot, chatbot, etc.) using any type of communication mode including, but not limited to, voice, audio, video, written (e.g., texts, chats, emails, images, etc.), etc. Further, in one or more examples, a risk-based event includes fraud or other risk-based events. Example types of fraud include improper taking or use of identity, improper and/or unauthorized transactions, improper taking of financial resources (e.g., money, funds, currency, notes, other financial assets, etc.), email phishing, internet-based improper actions, improper flight cancellations and/or other types of actions in which one user is attempting to deceive or take advantage of another user. A risk-based event may be an action (e.g., conversation), plan or scheme, as examples, that are used to deceive or take advantage of a user.

In one or more aspects, to predict a risk-based event and alert a user of the risk-based event, artificial intelligence is used. The artificial intelligence includes one or more types, fields and/or strategies, such as machine learning (e.g., uses data and algorithms to imitate the way humans learn) and/or generative artificial intelligence (e.g., one or more deep-learning models capable of generating content based on data on which they were trained), as examples. The artificial intelligence executes one or models (e.g., programs that apply algorithms(s) to data to learn, e.g., recognize patterns, make predictions and/or make decisions without human intervention). Example models that are generated and trained, in one or more aspects of the present disclosure, are a category model and a prediction model.

The category model, in one example, categorizes different events (e.g., risk-based events and/or non-risk-based events) based on analysis of data, such as historical data, to provide a plurality of process flows (may also be referred to as workflows) relating to the events. The prediction model, in one example, predicts whether a risk-based event is occurring in a real-time conversation. Based on the prediction model predicting a risk-based event and based on the real-time conversation, the category model is used to select a particular process flow of the plurality of process flows that corresponds to the real-time conversation and to indicate the potential of a risk-based event.

In one example, the category model and/or the prediction model are included in a messaging tool used in communicating between users. The messaging tool is included in each user's computing device, such as a mobile phone, telephone, tablet, laptop, computer, wearable device, etc. The messaging tool analyzes a real-time conversation between the users, predicts the probability of a risk-based event and alerts the user on the receiving end of the risk-based event of the potential of the risk-based event. The alert is, in one or more examples, a visual alert provided by the messaging tool.

In one or more aspects, a method is provided that includes executing a messaging tool on a computing device to conduct and analyze a real-time conversation between, at least, one user and another user. The messaging tool includes at least one artificial intelligence model generated and integrated into the messaging tool. The at least one artificial intelligence model is generated based on analyzing historical data obtained from one or more exogenous sources. The historical data includes, at least, data related to one or more historical risk-based events. The at least one artificial intelligence model is trained to categorize analysis data resulting from the analyzing the historical data and to predict a risk-based event. Using the messaging tool, real-time analysis of the real-time conversation is performed to generate a probability score. The probability score indicates a prediction that the real-time conversation is the risk-based event. The risk-based event is visualized using the messaging tool to indicate to a selected user that the real-time conversation is the risk-based event. The selected user is a user of the one user and the another user of the real-time conversation. By executing a messaging tool that integrates artificial intelligence models to be used to detect a risk-based event and provide an alert regarding the same improves communications with a user and facilitates processing within the computing device by enhancing security. A telecommunications network includes components (e.g., a messaging tool, network, processor) configured to facilitate communications between users and increases the speed of detecting a risk-based event by enabling real-time analysis and prediction.

Additionally, or alternatively, in one example, the at least one artificial intelligence model includes a category model trained to categorize the analysis data resulting from the analyzing the historical data and a prediction model trained to predict the risk-based event. A telecommunications network includes components (e.g., messaging tool having integrated therein a category model and a prediction model, network, processor) configured to facilitate communications between users and increases the speed of detecting a risk-based event by enabling real-time analysis and prediction.

Additionally, or alternatively, in one example, the historical data is obtained from the one or more exogenous sources via at least one network coupled to the computing device executing the messaging tool. By using exogenous sources and at least one network, the use of in-processor memory is reduced, optimizing memory accesses.

Additionally, or alternatively, in one example, the historical data includes data selected from a group of data consisting of emails, text messages, chats, phone recordings, audio recordings and account information. Processing speed is improved between a computing device and one or more repositories by searching particular types of data and use of storage is reduced by obtaining selected historical data.

Additionally, or alternatively, in one example, the visualizing the risk-based event includes visualizing the risk-based event using a graphical user interface of the messaging tool. Processing within a computing environment is improved by optimizing interactions between the computing device and the graphical user interface to visualize in real-time an alert (e.g., risk-based event).

Additionally, or alternatively, in one example, the method further includes analyzing the historical data relating to the one or more historical risk-based events, and generating a category model based on the analyzing the historical data. The category model is one model of the at least one artificial intelligence model, and the category model includes a plurality of categories of the historical data generated based on keywords of the historical data. Use of artificial intelligence increases processing speed and improves accuracy facilitating communications between users in either quickly identifying a risk-based event or eliminating such a concern. This also improves security within a telecommunications network.

Additionally, or alternatively, in one example, the method further includes generating one or more process flows based on the plurality of categories, in which a process flow of the one or more process flows indicates a particular type of risk-based event. This facilitates communication within, e.g., a telecommunications network by providing, in real-time, an indication of a risk-based event. Further, security within the network is enhanced.

Additionally, or alternatively, in one example, the performing the real-time analysis includes executing a prediction model to determine the probability score for the real-time conversation. The prediction model is another model of the at least one artificial intelligence model. Based on the probability score indicating that the real-time conversation is the risk-based event, the category model is executed to select a process flow of the one or more process flows coinciding with the real-time analysis of the real-time conversation. Use of artificial intelligence increases processing speed and improves accuracy, facilitating communications between users in either quickly identifying a risk-based event or eliminating such a concern. This also improves security within a computing environment.

Additionally, or alternatively, in one example, the probability score is generated based on a probability equation, in which the probability equation uses keywords and user information obtained from the real-time analysis of the real-time conversation. By individualizing the analysis, processing speed is enhanced, and real-time results are provided improving use and security of a telecommunications network.

Additionally, or alternatively, in one example, the visualizing includes depicting within the process flow a step of the process flow indicating the risk-based event. The visualization improves communication by readily alerting a user to the real-time event.

In accordance with one or more aspects, each of the embodiments is separable and optional from one another. Further, features of an embodiment may be separable and optional from each other. Moreover, embodiments and/or features may be combined with one another.

In one or more aspects, a computer program product is provided that includes a set of one or more computer-readable storage media, and program instructions, collectively stored in the set of one or more computer-readable storage media, for causing at least one computing device to perform computer operations including executing a messaging tool on a computing device of the at least one computing device to conduct and analyze a real-time conversation between, at least, one user and another user. The messaging tool includes at least one artificial intelligence model generated and integrated into the messaging tool. The at least one artificial intelligence model is generated based on analyzing historical data obtained from one or more exogenous sources. The historical data includes, at least, data related to one or more historical risk-based events. The at least one artificial intelligence model is trained to categorize analysis data resulting from the analyzing the historical data and to predict a risk-based event. Using the messaging tool, real-time analysis of the real-time conversation is performed to generate a probability score. The probability score indicates a prediction that the real-time conversation is the risk-based event. The risk-based event is visualized using the messaging tool to indicate to a selected user that the real-time conversation is the risk-based event. The selected user is a user of the one user and the another user of the real-time conversation. By executing a messaging tool that integrates artificial intelligence models to be used to detect a risk-based event and provide an alert regarding the same improves communications with a user and facilitates processing within the computing device by enhancing security. A telecommunications network includes components (e.g., a messaging tool, network, processor) configured to facilitate communications between users and increases the speed of detecting a risk-based event by enabling real-time analysis and prediction.

Additionally, or alternatively, in one example, the at least one artificial intelligence model includes a category model trained to categorize the analysis data resulting from the analyzing the historical data and a prediction model trained to predict the risk-based event. A telecommunications network includes components (e.g., messaging tool having integrated therein a category model and a prediction model, network, processor) configured to facilitate communications between users and increases the speed of detecting a risk-based event by enabling real-time analysis and prediction.

Additionally, or alternatively, in one example, the computer operations further include analyzing the historical data relating to the one or more historical risk-based events, and generating a category model based on the analyzing the historical data. The category model is one model of the at least one artificial intelligence model, and the category model includes a plurality of categories of the historical data generated based on keywords of the historical data. Use of artificial intelligence increases processing speed and improves accuracy facilitating communications between users in either quickly identifying a risk-based event or eliminating such a concern. This also improves security within a telecommunications network.

Additionally, or alternatively, in one example, the computer operations further include generating one or more process flows based on the plurality of categories, in which a process flow of the one or more process flows indicates a particular type of risk-based event. This facilitates communication within, e.g., a telecommunications network by providing, in real-time, an indication of a risk-based event. Further, security within the network is enhanced.

Additionally, or alternatively, in one example, the performing the real-time analysis includes executing a prediction model to conduct the real-time analysis of the real-time conversation to determine the probability score for the real-time conversation. The prediction model is another model of the at least one artificial intelligence model. Based on the probability score indicating that the real-time conversation is the risk-based event, the category model is executed to select a process flow of the one or more process flows coinciding with the real-time analysis of the real-time conversation. Use of artificial intelligence increases processing speed and improves accuracy, facilitating communications between users in either quickly identifying a risk-based event or eliminating such a concern. This also improves security within a computing environment.

In accordance with one or more aspects, each of the embodiments is separable and optional from one another. Further, features of an embodiment may be separable and optional from each other. Moreover, embodiments and/or features may be combined with one another.

In one or more aspects, a computer system is provided that includes at least one computing device, a set of one or more computer-readable storage media, and program instructions, collectively stored in the set of one or more computer-readable storage media, for causing the at least one computing device to perform computer operations including executing a messaging tool on a computing device of the at least one computing device to conduct and analyze a real-time conversation between, at least, one user and another user. The messaging tool includes at least one artificial intelligence model generated and integrated into the messaging tool. The at least one artificial intelligence model is generated based on analyzing historical data obtained from one or more exogenous sources. The historical data includes, at least, data related to one or more historical risk-based events. The at least one artificial intelligence model is trained to categorize analysis data resulting from the analyzing the historical data and to predict a risk-based event. Using the messaging tool, real-time analysis of the real-time conversation is performed to generate a probability score. The probability score indicates a prediction that the real-time conversation is the risk-based event. The risk-based event is visualized using the messaging tool to indicate to a selected user that the real-time conversation is the risk-based event. The selected user is a user of the one user and the another user of the real-time conversation. By executing a messaging tool that integrates artificial intelligence models to be used to detect a risk-based event and provide an alert regarding the same improves communications with a user and facilitates processing within the computing device by enhancing security. A telecommunications network includes components (e.g., a messaging tool, network, processor) configured to facilitate communications between users and increases the speed of detecting a risk-based event by enabling real-time analysis and prediction.

Additionally, or alternatively, in one example, the at least one artificial intelligence model includes a category model trained to categorize the analysis data resulting from the analyzing the historical data and a prediction model trained to predict the risk-based event. A telecommunications network includes components (e.g., messaging tool having integrated therein a category model and a prediction model, network, processor) configured to facilitate communications between users and increases the speed of detecting a risk-based event by enabling real-time analysis and prediction.

Additionally, or alternatively, in one example, the computer operations further include analyzing the historical data relating to the one or more historical risk-based events, and generating a category model based on the analyzing the historical data. The category model is one model of the at least one artificial intelligence model, and the category model includes a plurality of categories of the historical data generated based on keywords of the historical data. Use of artificial intelligence increases processing speed and improves accuracy facilitating communications between users in either quickly identifying a risk-based event or eliminating such a concern. This also improves security within a telecommunications network.

Additionally, or alternatively, in one example, the computer operations include generating one or more process flows based on the plurality of categories, in which a process flow of the one or more process flows indicates a particular type of risk-based event. This facilitates communication within, e.g., a telecommunications network by providing, in real-time, an indication of a risk-based event. Further, security within the network is enhanced.

Additionally, or alternatively, in one example, the performing the real-time analysis includes executing a prediction model to conduct the real-time analysis of the real-time conversation to determine the probability score for the real-time conversation. The prediction model is another model of the at least one artificial intelligence model. Based on the probability score indicating that the real-time conversation is the risk-based event, the category model is executed to select a process flow of the one or more process flows coinciding with the real-time analysis of the real-time conversation. Use of artificial intelligence increases processing speed and improves accuracy, facilitating communications between users in either quickly identifying a risk-based event or eliminating such a concern. This also improves security within a computing environment.

In accordance with one or more aspects, each of the embodiments is separable and optional from one another. Further, features of an embodiment may be separable and optional from each other. Moreover, embodiments and/or features may be combined with one another.

In one or more aspects, a method is provided that includes executing a messaging tool on a computing device to conduct and analyze a real-time conversation between, at least, one user and another user. The messaging tool includes at least one artificial intelligence model generated and integrated into the messaging tool. The at least one artificial intelligence model is generated based on analyzing historical data obtained from one or more exogenous sources. The historical data includes, at least, data related to one or more historical risk-based events. The at least one artificial intelligence model is trained to categorize analysis data resulting from the analyzing the historical data and to predict a risk-based event. Using the messaging tool, real-time analysis of the real-time conversation is performed to generate a probability score. The probability score indicates a prediction that the real-time conversation is the risk-based event. The risk-based event is visualized using the messaging tool to indicate to a selected user that the real-time conversation is the risk-based event. The selected user is a user of the one user and the another user of the real-time conversation. The at least one artificial intelligence model includes a category model trained to categorize the analysis data resulting from the analyzing the historical data and a prediction model trained to predict the risk-based event. The historical data is obtained from the one or more exogenous sources via at least one network coupled to the computing device executing the messaging tool. By using exogenous sources and at least one network, the use of in-processor memory is reduced, optimizing memory accesses. By executing a messaging tool that integrates artificial intelligence models to be used to detect a risk-based event and provide an alert regarding the same improves communications with a user and facilitates processing within the computing device by enhancing security. A telecommunications network includes components (e.g., a messaging tool having integrated therein a category model and a prediction model, network, processor) configured to facilitate communications between users and increases the speed of detecting a risk-based event by enabling real-time analysis and prediction.

In accordance with one or more aspects, each of the embodiments is separable and optional from one another. Further, features of an embodiment may be separable and optional from each other. Moreover, embodiments and/or features may be combined with one another.

In one or more aspects, a method is provided that includes executing a messaging tool on a computing device to conduct and analyze a real-time conversation between, at least, one user and another user. The messaging tool includes at least one artificial intelligence model generated and integrated into the messaging tool. The at least one artificial intelligence model is generated based on analyzing historical data obtained from one or more exogenous sources. The historical data includes, at least, data related to one or more historical risk-based events. The at least one artificial intelligence model is trained to categorize analysis data resulting from the analyzing the historical data and to predict a risk-based event. Using the messaging tool, real-time analysis of the real-time conversation is performed to generate a probability score. The probability score indicates a prediction that the real-time conversation is the risk-based event. The risk-based event is visualized using the messaging tool to indicate to a selected user that the real-time conversation is the risk-based event. The selected user is a user of the one user and the another user of the real-time conversation. The at least one artificial intelligence model includes a category model trained to categorize the analysis data resulting from the analyzing the historical data and a prediction model trained to predict the risk-based event. The historical data is obtained from the one or more exogenous sources via at least one network coupled to the computing device executing the messaging tool. The historical data includes data selected from a group of data consisting of emails, text messages, chats, phone recordings, audio recordings and account information. Processing speed is improved between a computing device and one or more repositories by searching particular types of data and use of storage is reduced by obtaining selected historical data. By using exogenous sources and at least one network, the use of in-processor memory is reduced, optimizing memory accesses. By executing a messaging tool that integrates artificial intelligence models to be used to detect a risk-based event and provide an alert regarding the same improves communications with a user and facilitates processing within the computing device by enhancing security. A telecommunications network includes components (e.g., a messaging tool having integrated therein a category model and a prediction model, network, processor) configured to facilitate communications between users and increases the speed of detecting a risk-based event by enabling real-time analysis and prediction.

In accordance with one or more aspects, each of the embodiments is separable and optional from one another. Further, features of an embodiment may be separable and optional from each other. Moreover, embodiments and/or features may be combined with one another.

In one or more aspects, a method is provided that includes executing a messaging tool on a computing device to conduct and analyze a real-time conversation between, at least, one user and another user. The messaging tool includes at least one artificial intelligence model generated and integrated into the messaging tool. The at least one artificial intelligence model is generated based on analyzing historical data obtained from one or more exogenous sources. The historical data includes, at least, data related to one or more historical risk-based events. The at least one artificial intelligence model is trained to categorize analysis data resulting from the analyzing the historical data and to predict a risk-based event. Using the messaging tool, real-time analysis of the real-time conversation is performed to generate a probability score. The probability score indicates a prediction that the real-time conversation is the risk-based event. The risk-based event is visualized using the messaging tool to indicate to a selected user that the real-time conversation is the risk-based event. The selected user is a user of the one user and the another user of the real-time conversation. The at least one artificial intelligence model includes a category model trained to categorize the analysis data resulting from the analyzing the historical data and a prediction model trained to predict the risk-based event. The visualizing the risk-based event includes visualizing the risk-based event using a graphical user interface of the messaging tool. Processing within a computing environment is improved by optimizing interactions between the computing device and the graphical user interface to visualize in real-time an alert (e.g., risk-based event). By executing a messaging tool that integrates artificial intelligence models to be used to detect a risk-based event and provide an alert regarding the same improves communications with a user and facilitates processing within the computing device by enhancing security. A telecommunications network includes components (e.g., a messaging tool having integrated therein a category model and a prediction model, network, processor) configured to facilitate communications between users and increases the speed of detecting a risk-based event by enabling real-time analysis and prediction.

In accordance with one or more aspects, each of the embodiments is separable and optional from one another. Further, features of an embodiment may be separable and optional from each other. Moreover, embodiments and/or features may be combined with one another.

In one or more aspects, a method is provided that includes executing a messaging tool on a computing device to conduct and analyze a real-time conversation between, at least, one user and another user. The messaging tool includes at least one artificial intelligence model generated and integrated into the messaging tool. The at least one artificial intelligence model is generated based on analyzing historical data obtained from one or more exogenous sources. The historical data includes, at least, data related to one or more historical risk-based events. The at least one artificial intelligence model is trained to categorize analysis data resulting from the analyzing the historical data and to predict a risk-based event. Using the messaging tool, real-time analysis of the real-time conversation is performed to generate a probability score. The probability score indicates a prediction that the real-time conversation is the risk-based event. The risk-based event is visualized using the messaging tool to indicate to a selected user that the real-time conversation is the risk-based event. The selected user is a user of the one user and the another user of the real-time conversation. The method further includes analyzing the historical data relating to the one or more historical risk-based events, and generating a category model based on the analyzing the historical data. The category model is one model of the at least one artificial intelligence model, and the category model includes a plurality of categories of the historical data generated based on keywords of the historical data. The method further includes generating one or more process flows based on the plurality of categories, in which a process flow of the one or more process flows indicates a particular type of risk-based event. The performing the real-time analysis includes executing a prediction model to determine the probability score for the real-time conversation. The prediction model is another model of the at least one artificial intelligence model. Based on the probability score indicating that the real-time conversation is the risk-based event, the category model is executed to select a process flow of the one or more process flows coinciding with the real-time analysis of the real-time conversation. The visualizing the risk-based event includes visualizing the risk-based event using a graphical user interface of the messaging tool. The visualizing includes depicting within the process flow a step of the process flow indicating the risk-based event. The visualization improves communication by readily alerting a user to the real-time event. Processing within a computing environment is improved by optimizing interactions between the computing device and the graphical user interface to visualize in real-time an alert (e.g., risk-based event). By executing a messaging tool that integrates artificial intelligence models to be used to detect a risk-based event and provide an alert regarding the same improves communications with a user and facilitates processing within the computing device by enhancing security. A telecommunications network includes components (e.g., a messaging tool, network, processor) configured to facilitate communications between users and increases the speed of detecting a risk-based event by enabling real-time analysis and prediction. Use of artificial intelligence increases processing speed and improves accuracy facilitating communications between users in either quickly identifying a risk-based event or eliminating such a concern. This also improves security within a telecommunications network. This facilitates communication within, e.g., a telecommunications network by providing, in real-time, an indication of a risk-based event. Further, security within the network is enhanced.

In accordance with one or more aspects, each of the embodiments is separable and optional from one another. Further, features of an embodiment may be separable and optional from each other. Moreover, embodiments and/or features may be combined with one another.

In one or more aspects, a method is provided that includes executing a messaging tool on a computing device to conduct and analyze a real-time conversation between, at least, one user and another user. The messaging tool includes at least one artificial intelligence model generated and integrated into the messaging tool. The at least one artificial intelligence model is generated based on analyzing historical data obtained from one or more exogenous sources. The historical data includes, at least, data related to one or more historical risk-based events. The at least one artificial intelligence model is trained to categorize analysis data resulting from the analyzing the historical data and to predict a risk-based event. Using the messaging tool, real-time analysis of the real-time conversation is performed to generate a probability score. The probability score indicates a prediction that the real-time conversation is the risk-based event. The risk-based event is visualized using the messaging tool to indicate to a selected user that the real-time conversation is the risk-based event. The selected user is a user of the one user and the another user of the real-time conversation. The historical data is obtained from the one or more exogenous sources via at least one network coupled to the computing device executing the messaging tool. The historical data includes data selected from a group of data consisting of emails, text messages, chats, phone recordings, audio recordings and account information. Processing speed is improved between a computing device and one or more repositories by searching particular types of data and use of storage is reduced by obtaining selected historical data. The method further includes analyzing the historical data relating to the one or more historical risk-based events, and generating a category model based on the analyzing the historical data. The category model is one model of the at least one artificial intelligence model, and the category model includes a plurality of categories of the historical data generated based on keywords of the historical data. Use of artificial intelligence increases processing speed and improves accuracy facilitating communications between users in either quickly identifying a risk-based event or eliminating such a concern. This also improves security within a telecommunications network. By using exogenous sources and at least one network, the use of in-processor memory is reduced, optimizing memory accesses. By executing a messaging tool that integrates artificial intelligence models to be used to detect a risk-based event and provide an alert regarding the same improves communications with a user and facilitates processing within the computing device by enhancing security. A telecommunications network includes components (e.g., a messaging tool, network, processor) configured to facilitate communications between users and increases the speed of detecting a risk-based event by enabling real-time analysis and prediction.

In one or more aspects, a real-time conversation between multiple users is analyzed, in real-time, to determine whether a user is being deceived, and thus, at risk of a risk-based event (e.g., fraud). If it is determined that the user is at risk of the risk-based event, the user is visually alerted during the real-time conversation via, e.g., a process flow of an artificial intelligence model (e.g., a category model).

Methods, computer program products and computer systems relating to one or more aspects are described and claimed herein. Each of the embodiments of the method may be embodiments of each computer system and/or each computer program product and vice-versa. Further, each of the embodiments is separable and optional from one another. Moreover, embodiments may be combined with one another. Further, features of an embodiment may be separable and optional from each other. Moreover, each of the embodiments and/or features of the method may be combinable with aspects and/or embodiments of each computer system and/or computer program product, and vice-versa.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of performing risk-based event prediction and alerting and/or performing one or more other aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

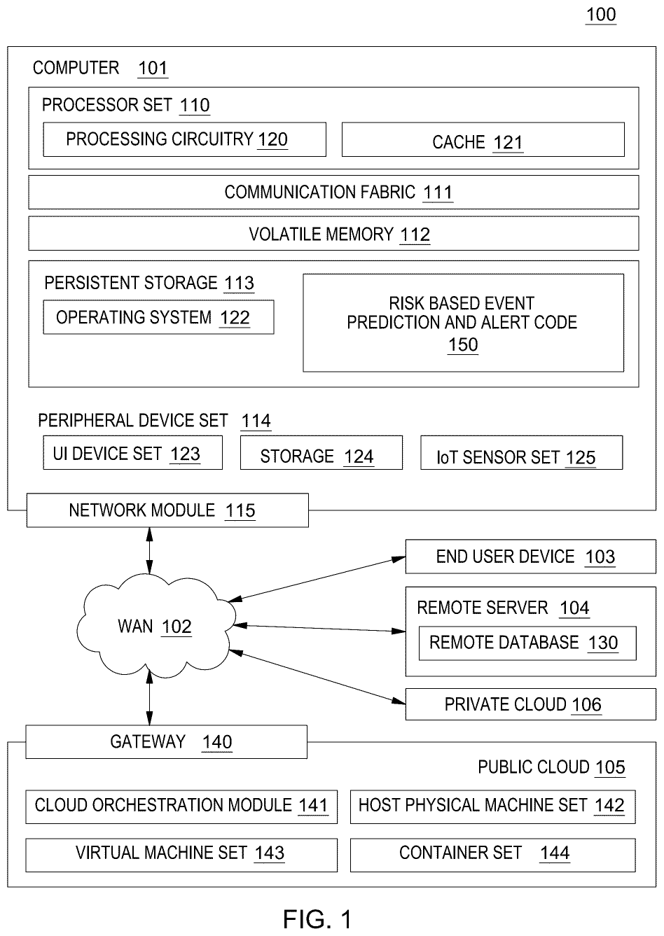

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as risk-based event prediction and alert code 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, a wearable device (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106, 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. For instance, in one or more embodiments, one or more of the components/modules/blocks of FIG. 1 are not included in the computing environment and/or are not used for one or more aspects of the present disclosure. Further, in one or more embodiments, additional and/or other components/modules/blocks may be used. Other variations are possible.

In one example, at least a portion of the computing environment is, or is at least part of, a telecommunications network used in conversation between users. There may be two or more users as part of the conversation. As described herein, the conversation may be a risk-based event (e.g., an event that poses a risk to a user). Thus, in accordance with one or more aspects, risk-based prediction and alerting are performed.

In one example, to perform risk-based prediction and to provide an alert, risk-based event prediction and alert code (e.g., risk-based event prediction and alert code 150) is used, in accordance with one or more aspects of the present disclosure. In one example, risk-based event prediction and alert code (e.g., risk-based event prediction and alert code 150) includes code or instructions used to predict a risk-based event and to provide an alert regarding the risk-based event, in accordance with one or more aspects of the present disclosure. The code is, e.g., computer-readable program code (e.g., instructions) in computer-readable media, e.g., storage (e.g., persistent storage 113, cache 121, storage 124, other storage, as examples). The computer-readable media may be part of a computer program product and the computer-readable program code may be executed by and/or using one or more computing devices (e.g., one or more computers, such as computer(s) 101, etc. ; one or more servers, such as remote server(s) 104, etc.; one or more processors or nodes, such as processor(s) or node(s) of processor set 110; processing circuitry, such as processing circuitry 120 of processor set 110; one or more telephones; one or more mobile phones; one or more tablets; one or more laptop computers; one or more wearable devices; and/or other computing devices, etc.). Additional and/or other computing devices, computers, servers, processors, nodes and/or processing circuitry may be used to execute the code and/or portions thereof. Many examples are possible.

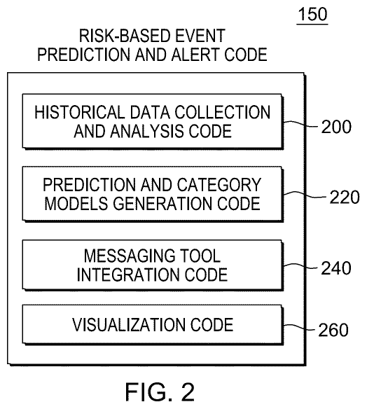

One example of risk-based event prediction and alert code 150 is described with reference to FIG. 2. In one example, risk-based event prediction and alert code 150 includes historical data collection and analysis code 200 to be used to collect historical data relating to risk-based events and non-risk-based events and to analyze the collected historical data; prediction and category models generation code 220 to be used to generate a prediction model and a category model based on the analysis; messaging tool integration code 240 to be used to integrate artificial intelligence models (e.g., the prediction model and the category model) into a messaging tool; and visualization code 260 to be used to visualize a risk-based event and/or one or more alerts associated therewith. Additional, less and/or other code may be provided and/or used in one or more aspects of the present disclosure.

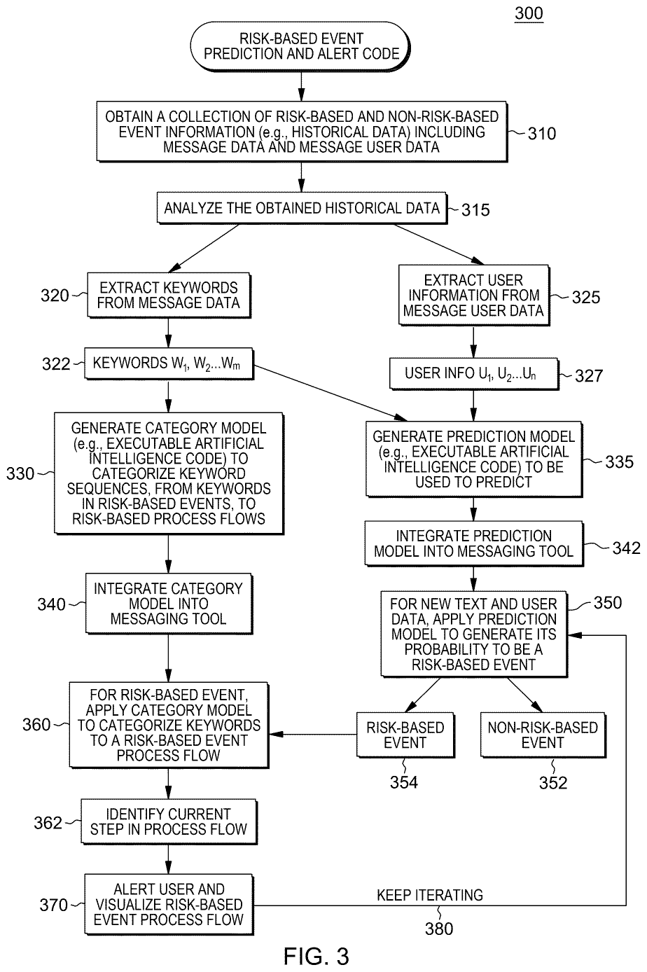

In one example, risk-based event prediction and alert code 150 includes code (e.g., code 200-260) that is used in risk-based event prediction and alert processing, as further described in one example with reference to FIG. 3. FIG. 3 depicts one example of a risk-based event prediction and alert process 300 that is executed by one or more computing devices (e.g., a computer (e.g., computer 101, other computer, etc.), a server (e.g., server 104, other server, etc.), an end user device (e.g., end user device 103, other end user device, etc.), a processor, node and/or processing circuitry, etc. (e.g., of processor set 110 or other processor sets); a telephone; a mobile phone; a laptop; a tablet; a wearable device and/or one or more other computing devices, etc.). Although example computers, servers, end user devices, processors, nodes, processing circuitry, telephones, mobile phones, laptops, tablets, wearable devices and/or other computing devices are provided, additional, fewer and/or other computers, servers, end user devices, processors, nodes, processing circuitry, telephones, mobile phones, laptops, tablets, wearable devices and/or computing devices may be used for a risk-based event prediction and alert process and/or other processing. Various options are possible.

Referring to FIG. 3, in one example, risk-based event prediction and alert process 300 (also referred to as process 300) is used to dynamically and automatically predict a risk-based event, e.g., during a conversation, and provide an alert regarding the event. In one or more aspects, process 300 collects and analyzes historical data of risk-based events and non-risk-based events to extract existing or known risk-based events. In the analyzed data, in one example, selected points where users are susceptible to risk-based events (e.g., susceptible to being deceived), the probability of being a part of the risk-based event, being deceived and/or the targeted audience are labeled.

In one example, process 300 includes obtaining 310 (e.g. retrieving, extracting, pulling, collecting, determining, searching, being provided, receiving, being transmitted, etc.) a collection of risk-based event and non-risk-based event information (e.g., historical data). In one example, process 300, using, e.g., historical data collection and analysis code 200, obtains 310 (e.g., over one or more networks) historical data from a plurality of exogenous sources relating to risk-based and/or non-risk-based events. For example, the historical data is obtained from databases, datasets, data collections, other written works, audio works, video works, etc. that include such historical data.

In one example, the obtained historical data may include data relating to one or more previous conversations (referred to as message data) and/or data relating to users of the one or more previous conversations (referred to as message user data). As indicated, a conversation is a communication between at least two users, and the communication can be by any technique, including, but not limited to, voice, such as on a telephone, mobile phone, through audio on a computing device, such as a laptop, computer, tablet, wearable device, etc. ; messaging, such as texts, chats, emails, etc. Many examples of communications, computing devices and/or conversations are possible. Further, users may be human or non-human; a user is any entity that may be a participant in a conversation. As examples, the obtained message data may include, e.g., conversational content (e.g., from text messages, phone recordings, audio recordings captured on a computing device, chats, emails, etc.), and the message user data may include, e.g., message history (e.g., a history of the conversation), message frequency, related account information, such as, account age, phone numbers, messaging protocol dial numbers, internet protocol addresses, etc. Other examples are possible for both the message data and the message user data.

As an example, process 300 obtains a large amount of historical data relating to both risk-based and non-risk-based events, including, but not limited to, emails, text messages, chats, phone and/or audio recordings, and related account information. The historical risk-based events are extracted, in one example, and the historical risk-based events and historical data relating thereto are analyzed to identify selected features of a risk-based event (e.g., action, plan or scheme), such as patterns and keywords (e.g., how users are systematically brought into a risk-based event). Further, in one example, the analyzed data is labeled indicating selected points where users are susceptible to a risk-based event, the probability of being deceived and/or the targeted audience. Aspects of this processing are further described herein.

For example, based on the obtained historical data, process 300 analyzes 315 the obtained historical data and, in one or more examples, labels the analyzed data, indicating points where users are susceptible to a risk-based event, the probability of being included in the risk-based event and/or the targeted audience. In one example, process 300 analyzes 315 the historical data to identify selected features of the risk-based events, such as patterns and keywords indicating, for instance, where and/or how users are systematically drawn into a risk-based event. In one example, process 300 extracts 320 keywords from the message data, such as, for instance, keywords W1, W2 . . . Wm 322, and extracts 325 user information from the message user data, such as, user information U1, U2 . . . Un 327. Example keywords include, for instance, a request of account information or monetary contribution, overdue invoice, name or indication of a person or other entity known or associated to the unsuspecting user, etc.; and user information includes, for instance, phone number, internet protocol address, other user identifying information, etc. Additional, fewer and/or other message data, keywords, user information and/or message user data examples are possible.

Based on the analysis, in one example, at least one artificial intelligence model (e.g., a category model and a prediction model) is derived. For example, from keywords extracted from historical risk-based events, machine learning is used (e.g., run) to get (e.g., generate (e.g., derive, create, select, train, retrain, etc.)) a category model (e.g., a risk-based category model) to categorize keyword sequences (of, e.g., historical data) to risk-based process flows; and machine learning is used (e.g., run) to get (e.g., generate (e.g., derive, create, select, train, retrain, etc.)) a prediction model (e.g., a risk-based prediction model) to be used to predict a current risk-based event. For instance, in one or more aspects, the language and tactics used in various previous risk-based events (e.g., fraud cases), the relationships and sequences between each stage are analyzed. Further, in one example, the counterpart's account is analyzed based on various dimensions, such as whether the users know one another, common friends/acquaintances, account is verified or not, account age, internet protocol address, etc. Based on this data, in one example, at least one artificial intelligence model (e.g., executable artificial intelligence code) is generated. For example, in one embodiment, a category model and a prediction model are created. As examples, texts and other messaging data are grouped based on similarities to uncover different patterns of risk-based events. Analysis of the data (e.g., text analysis and/or other analysis) is conducted to create in a category model specific process flows (also referred to as workflows) for different risk-based events, enabling the process flows to possess learning capabilities for continuous expansion and optimization. Further, the data analysis provides keywords and user information used to generate (e.g., derive, create, select, train, retrain) a prediction model. Then, based on real-time messages (e.g., a current conversation), the prediction model is used to determine whether the current case (e.g., conversation) is a risk-based event. Aspects of this processing are further described herein.

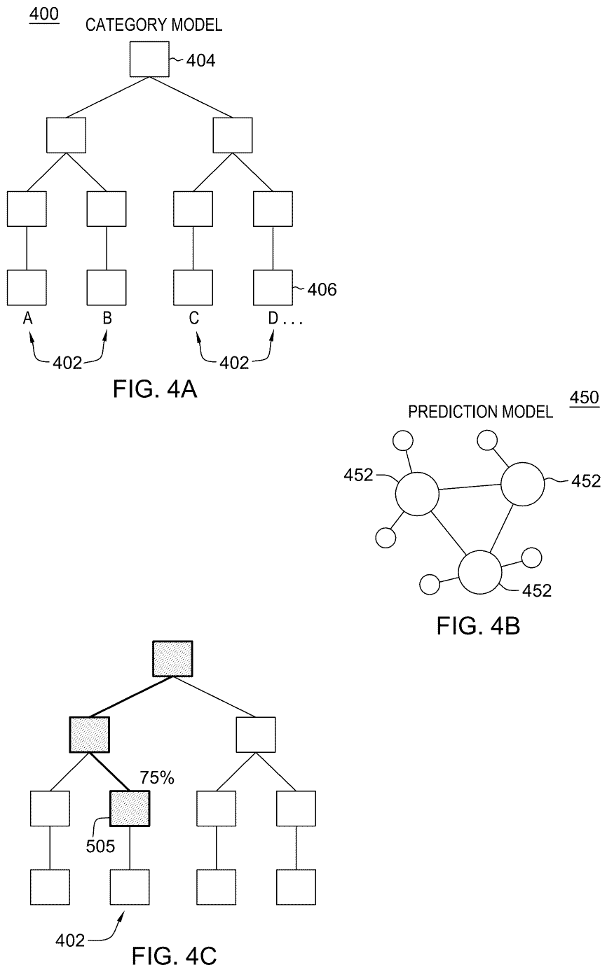

For example, based on keywords extracted from historical risk-based events, process 300 generates 330, using, e.g., prediction and category models generation code 220, a category model (e.g., a risk-based event category model). The category model is an artificial intelligence model (e.g., a machine learning model; executable artificial intelligence code) that is trained (and retrained) to categorize keyword sequences, from extracted keywords, as risk-based event process flows. One example of a category model is depicted in FIG. 4A.

Referring to FIG. 4A, in one example, a category model 400, such as a risk-based event category model, includes a plurality of categories of risk-based events, each of which is presented as a process flow 402 (also referred to as a workflow). A process flow 402 includes one or more nodes, starting at a root node 404 and ending at a leaf node 406. Each node represents one or more keywords of the analyzed historical data, and a process flow represents a sequence of keywords.

Returning to FIG. 3, based on the extracted keywords and user information, process 300 generates 335, using, e.g., prediction and category models generation code 220, a prediction model (e.g., a risk-based event prediction model). The prediction model is an artificial intelligence model (e.g., a machine learning model; executable artificial intelligence code) that is trained (and retrained) to predict a risk-based event. One example of a prediction model is depicted in FIG. 4B.

Referring to FIG. 4B, in one example, a prediction model 450, such as a risk-based event prediction model, receives as input 452 the extracted keywords of, e.g., historical risk-based events, an indication of historical risk-based events and/or user information of, e.g., historical risk-based events, and based on a generated equation (an example of which is described herein), outputs a probability score that indicates the probability that a real-time conversation is a risk-based event.

Based on generating the category model (e.g., category model 400) and the prediction model (e.g., prediction model 450), they are integrated into one or more messaging tools so that real-time analysis of current real-time conversations may be conducted to, e.g., calculate the probability of a risk-based event and determine one or more specific process flows which fall into the risk-based event. For instance, based on the start of the real-time conversation, a category model (e.g. category model 400) is integrated into a messaging tool (unless previously integrated) and used to determine for a suspicious risk-based event, which specific process flow (e.g., risk-based schemes/overlaying schemes, etc.) the text analysis and/or other data analysis falls; and a prediction model (e.g., prediction model 450) is integrated into a messaging tool (unless previously integrated) and used to conduct real-time analysis of the real-time conversation to calculate the probability of a risk-based event. Aspects of this processing are further described herein.

For example, in one or more aspects, returning to FIG. 3, process 300 integrates 340, 342 (e.g., using messaging tool integration code 240) the category model (e.g., category model 400) and the prediction model (e.g., prediction model 450) into a messaging tool executing on a computing device. The computing device may be the same device performing the prior tasks of process 300 and/or it may be a different computing device coupled to the computing device performing the prior tasks. Various examples are possible. The integration includes, as examples, installing, including, embedding, turning on and/or setting an indicator to specify the models. As indicated, the category model (e.g., category model 400) and the prediction model (e.g., prediction model 450) are executable artificial intelligence code (e.g., machine learning code) trained/retrained to predict whether a particular real-time conversation is a risk-based event, and if so, alert the unsuspecting user of such.

In one example, process 300 applies 350 (e.g., executes) on the messaging tool the trained prediction model for new text and user data obtained during a real-time conversation to predict whether there is a risk-based event. For example, the messaging tool uses the prediction model to determine whether the current case (e.g., real-time conversation) is a risk-based event. The prediction model, in one embodiment, determines a probability score indicating the probability of whether the real time conversation is a risk-based event. In one example, the prediction model uses an equation, such as:

Probability of case Ai with message keywords (W) and user info (U) is a risk-based event (R): (Bayes' rule):

$$P ( R \vert W , U ) = PW , U \vert R * P ( R ) / P ( W , U ) = PW \vert R * P ( U \vert R ) * P ( R ) / PW * P ( U ) = PW 1 \vert R … PWm \vert R * P ( U 1 \vert R ) … P ( U n \vert R ) * P ( R ) / PW 1 … PWm * PU 1 … P ( U n ) .$$

Other equations/formulas are possible.

Should the probability of a risk-based event have a predefined relationship with a selected threshold (e.g., less than X %, where X is a preselected number, such as 60% or another preselected number), process 300, using the messaging tool, determines 352 that the event is a non-risk-based event. However, should the probability of the risk-based event have another predefined relationship with a selected threshold (e.g., greater than or equal to X %, where X is a preselected number, such as 60% or another preselected number), process 300 determines 354 that the event is a risk-based event. Thus, for the risk-based event, process 300 applies 360 (e.g., executes) on the messaging tool the trained category model to categorize keywords of the real-time conversation to a risk-based event process flow of the category model.

Process 300, using the messaging tool, identifies 362 a current step in a selected process flow (e.g., one corresponding to, e.g., keywords of the real-time conversation) at which it is determined that a risk-based event is occurring, and alerts 370 the user. For instance, process 300, using the messaging tool, visualizes (e.g., using visualization code 260) the risk-based event in the process flow. As an example, the risk-based event is visualized in a graphical user interface of the messaging tool to assist users in receiving alerts with possible risk-based events in the conversation or get blocked to avoid the risk-based event. The visualization may use defined markers or colors for conversation display, or any other type of indications. Many examples are possible.

In one example, referring to FIG. 4C, a process flow 402 is highlighted and in this particular example, at node 505 (indicating a step in the process flow), the probability of a risk-based event is reached, e.g., 75% (which, in this case, is above a predefined probability threshold), and therefore, indicates that the conversation is a risk-based event. This is visually depicted by, e.g., the highlighting in FIG. 4C. However, other indications may be used to alert the user. Many examples are possible.

For instance, in one or more examples, various risk-based events are visualized in real-time within, e.g., a chat application, presenting the risk-based events and their connections based on the chatting. The process flow may be embedded in the chat application's dialogue interface using, e.g., icons, labels and/or pop-ups. Users can intuitively see warnings and reminders during conversations.

As examples, detailed reports, e.g., at a certain point in the conversation (e.g., when the probability reaches a predefined threshold) may be provided that includes, for instance, the probability of a suspected risk-based event, number of users that have been deceived, etc.; markers and/or color coding may be used to highlight potential risk-based events, enabling users to quickly discern the risk; process flows may be made interactive, allowing users to click on, e.g., icons and/or labels to obtain more detailed information, such as, for instance, how to respond or how to ask questions to guide the suspicious individuals and verify whether their next steps align with the risk-based event; and/or automatic blocking and/or providing enhanced security measures may be implemented for potential high-risk conversations. Many other examples are possible.

Returning to FIG. 3, in one example, process 300 continues 380 to iterate for new text and user data. Further, in one or more examples, based on executing the models and iterating, the prediction model and/or the category model may be retrained based on learned results from executing the models and/or based on further analysis. This provides a more robust and accurate prediction of whether a given real-time conversation is a risk-based event. Further, this improves processing speed of the messaging tool by fine-tuning the models.

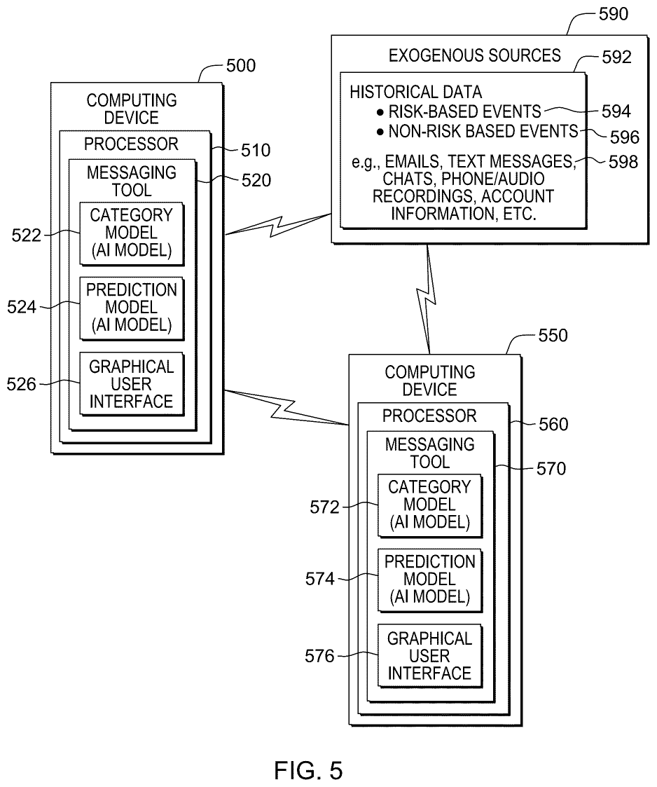

As indicated above, in one or more examples, the category model and the prediction model are integrated into a messaging tool (e.g., software and/or hardware used in communication). One example of such a tool is depicted in FIG. 5. As shown, in one example, one computing device 500 (e.g., computer, telephone, mobile phone, laptop, tablet, wearable device, other computing device, etc.) is coupled to another computing device 550 (e.g., computer, telephone, mobile phone, laptop, tablet, wearable device, other computing device, etc.). Computing device 500 includes, for instance, a processor 510 that executes a messaging tool 520. Messaging tool 520 includes, for instance, at least one category model (AI (artificial intelligence) model) 522, at least one prediction model (AI (artificial intelligence) model) 524 and at least one graphical user interface (GUI) 526. Similarly, computing device 550 includes, for instance, a processor 560 that executes a messaging tool 570. Messaging tool 570 includes, for instance, at least one category model (AI (artificial intelligence) model) 572, at least one prediction model (AI (artificial intelligence) model) 574 and at least one graphical user interface (GUI) 576.

In one example, at least one of the computing devices (e.g., computing device 500 and/or computing device 550) and/or one or more components thereof is coupled (e.g., via one or more networks) to one or more exogenous sources 590 that include historical data 592 related to risk-based events 594 and non-risk-based events 596. Examples 598 of historical data include, but are not limited to, emails, text messages, chats, phone/audio recordings, account information, etc. Many examples are possible.

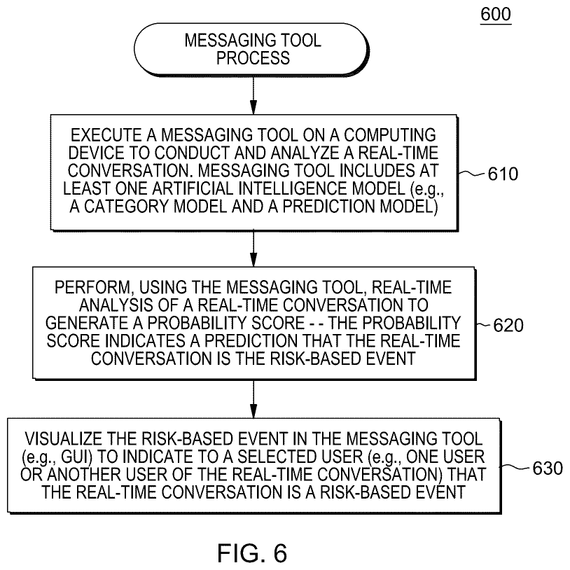

One example of further details of using a messaging tool (e.g., messaging tool 520, 570) is described with reference to FIG. 6. FIG. 6 depicts one example of a messaging tool process 600 that is executed by one or more computing devices, such as computing device 500, 550 (e.g., a computer (e.g., computer 101, other computer, etc.), a server (e.g., server 104, other server, etc.), an end user device (e.g., end user device 103, other end user device, etc.), a processor, node and/or processing circuitry, etc. (e.g., of processor set 110 or other processor sets), a telephone, a mobile phone, a laptop, a tablet, a wearable device and/or one or more other computing devices, etc.). Although example computers, servers, end user devices, processors, nodes, processing circuitry, telephones, mobile phones, laptops, tablets, wearable devices and/or other computing devices are provided, additional, fewer and/or other computers, servers, end user devices, processors, nodes, processing circuitry, telephones, mobile phones, laptops, tablets, wearable devices and/or computing devices may be used for a messaging tool process and/or other processing. Various options are possible.

In one example, messaging tool process 600 (also referred to as process 600) includes executing 610 a messaging tool (e.g., messaging tool 520, 570) on a computing device (e.g., computing device 500, 550, such as a computer, telephone, mobile phone, laptop, tablet, wearable device and/or one or more other computing devices, etc.) to conduct and analyze a real-time conversation. The messaging tool (e.g., messaging tool 520, 570) includes, for example, at least one artificial intelligence model, such as a category model (e.g., category model 522, 572) and/or a prediction model (e.g., prediction model 524, 574) used to analyze a real-time conversation, predict whether the real-time conversation is a risk-based event and/or to alert a user based on predicting the risk-based event.

Process 600 performs 620, using the messaging tool (e.g., messaging tool 520, 570), real-time analysis of a real-time conversation to generate a probability score. The probability score indicates, in one example, a prediction that the real-time conversation is the risk-based event.

Process 600 visualizes 630 the risk-based event in the messaging tool (e.g., messaging tool 520, 570) using, for instance, a graphical user interface (e.g., graphical user interface (GUI) 526, 576) to indicate to a selected user (e.g., one user or another user of the real-time conversation) that the real-time conversation is a risk-based event.

Described above is one example of prediction and alert processing for real-time conversations. The processing may use artificial intelligence including, machine learning. For instance, machine learning and/or other artificial intelligence may be used to train the models, perform analysis, provide a prediction, provide an alert and/or perform other tasks. A system is trained to perform analyses and learn from input data and/or choices made.

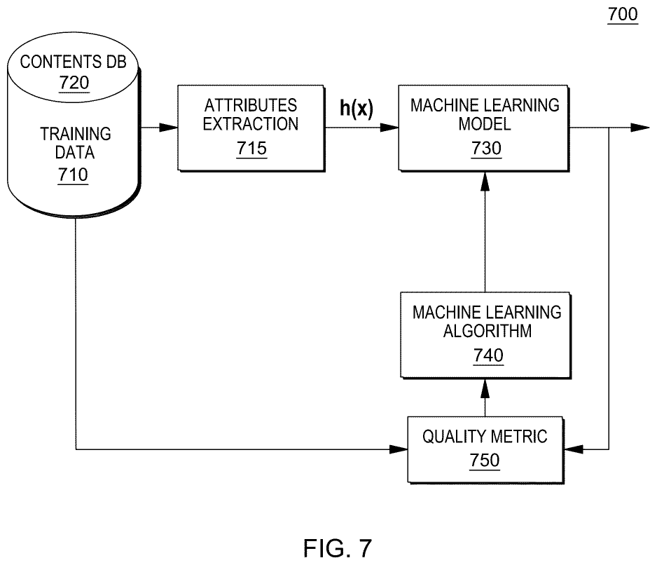

One example of a machine learning training system is described with reference to FIG. 7. In one or more aspects, a machine learning training system 700 may be utilized to perform cognitive analyses of various inputs, including input data, data from one or more sources (e.g., exogenous sources and/or other sources), repositories, data structures and/or other data. The data may include message data and/or user message data, etc. Training data 710 utilized to train the model in one or more embodiments of the present disclosure includes, for instance, data that pertains to one or more events (e.g., risk-based events), such as natural language processing data, data being processed; data that pertains to conversations; data obtained from exogenous sources; actions that have been taken; and/or available resources; etc. The program code in embodiments of the present disclosure performs a cognitive analysis to generate one or more training data structures, including algorithms utilized by the program code to predict states of a given event (e.g., risk-based event, etc.). Machine learning (ML) solves problems that are not solved with numerical means alone. In this ML-based example, program code extracts various attributes from ML training data 710 (e.g., historical data collected from various data sources relevant to the event (e.g., risk-based events, non-risk-based events)), which may be resident in one or more databases 720 comprising event or other data. Attributes 715 are utilized to develop a predictor function, h(x), also referred to as a hypothesis, which the program code utilizes as a machine learning model 730.

In identifying various event states, features, attribute similarities, constraints and/or behaviors indicative of states in the ML training data 710, the program code can utilize various techniques to identify attributes in an embodiment of the present disclosure. Embodiments of the present disclosure utilize varying techniques to select attributes (data attributes, elements, patterns, features, constraints, distribution, etc.), including but not limited to, diffusion mapping, principal component analysis, recursive feature elimination (a brute force approach to selecting attributes), and/or a Random Forest, to select the attributes related to various events. The program code may utilize a machine learning algorithm 740 to train the machine learning model 730 (e.g., the algorithms utilized by the program code), including providing weights for the conclusions, so that the program code can train the predictor functions that comprise the machine learning model 730. The conclusions may be evaluated by a quality metric 750. By selecting a diverse set of ML training data 710, the program code trains the machine learning model 730 to identify and weight various attributes (e.g., data attributes, features, patterns, constraints, distributions, etc.) that correlate to various states of an event.

The model generated by the program code is self-learning as the program code updates the model based on active event feedback, as well as from the feedback received from data related to the event (e.g., risk-based event). For example, when the program code determines that there is a constraint, event, similarity or pattern (e.g., data attribute, record attribute similarity, query pattern, data distribution, search terms distribution, etc.) that was not previously predicted by the model, the program code utilizes a learning agent to update the model to reflect the state of the event, in order to improve predictions in the future. Additionally, when the program code determines that a prediction is incorrect, either based on receiving user feedback through an interface or based on monitoring related to the event, the program code updates the model to reflect the inaccuracy of the prediction for the given period of time. Program code comprising a learning agent cognitively analyzes the data deviating from the modeled expectations and adjusts the model to increase the accuracy of the model, moving forward.

In one or more embodiments, program code, executing on one or more processors, utilizes a cognitive analysis tool or agent (now known or later developed) to tune the model, based on data obtained from one or more data sources. In one or more embodiments, the program code interfaces with application programming interfaces to perform a cognitive analysis of obtained data. Specifically, in one or more embodiments, certain application programming interfaces comprise a cognitive agent (e.g., learning agent) that includes one or more programs, including, but not limited to, natural language classifiers, a retrieve and rank service that can surface the most relevant information from a collection of documents, concepts/visual insights, trade off analytics, document conversion, and/or relationship extraction. In an embodiment, one or more programs analyze the data obtained by the program code across various sources utilizing one or more of a natural language classifier, retrieve and rank application programming interfaces, and trade off analytics application programming interfaces. An application programming interface can also provide audio related application programming interface services, in the event that the collected data includes audio, which can be utilized by the program code, including but not limited to natural language processing, text to speech capabilities, and/or translation.

In one or more embodiments, the program code utilizes a neural network to analyze event-related data to generate the model utilized to predict the state of a given event at a given time. Neural networks are biologically-inspired programming paradigms, which enable a computer to learn and solve artificial intelligence problems. This learning is referred to as deep learning, which is a subset of machine learning, an aspect of artificial intelligence, and includes a set of techniques for learning in neural networks. Neural networks, including modular neural networks, are capable of pattern recognition with speed, accuracy, and efficiency, in situations where data sets are multiple and expansive, including across a distributed network, including but not limited to, cloud computing systems. Modern neural networks are non-linear statistical data modeling tools. They are usually used to model complex relationships between inputs and outputs or to identify patterns (or similarities) in data (i.e., neural networks are non-linear statistical data modeling or decision-making tools). In general, program code utilizing neural networks can model complex relationships between inputs and outputs and identify patterns in data. Because of the speed and efficiency of neural networks, especially when parsing multiple complex data sets, neural networks and deep learning provide solutions to many problems in multiple source processing, which the program code in one or more embodiments accomplishes when obtaining data and generating a model for predicting states of a given event.

As described herein, artificial intelligence (e.g., trained/retrained models) are used to predict whether a real-time conversation is a risk-based event. If it is determined to be a risk-based event, an indication is presented to a user (e.g., a participant of the real-time conversation) to alert the user of the risk-based event. The models are generated, trained (retrained) and integrated into a messaging tool for use in real-time.

In one or more aspects, a real-time visualization process flow is provided that can indicate risk-based events detected based on, e.g., text analysis and/or other data analysis; facilitate recognition of the risk-based patterns, step-by-step; visualize the risk-based event to be able to take actions to prevent the risk-based event, thereby preventing, e.g., loss, such as financial loss and/or other types of losses. By implementing artificial intelligence and natural language processing in a risk-based event detection process, pattern and/or loophole detection are facilitated in risk-based events.

One or more aspects identify signals within a conversation that may be used to identify a risk-based event and to prevent such an event. For example, when a conversation participant claims to be an information technology worker and that participant is asked about the languages it uses and the participant replies with a language other than a programming language, an alert may be provided to another participant of the conversation that the another participant may be being deceived.

One or more aspects are tied to computer technology and facilitate processing within a computer, improving performance thereof. In one or more aspects, technical fields of computing, telecommunications and artificial intelligence are improved. For instance, the generation and/or execution of artificial intelligence models to predict a risk-based event is facilitated and/or improved. Processing is facilitated by dynamically updating a process flow. The dynamic generation and integration of the models saves on memory/storage requirements by not requiring storing of each possible model. Further, storage is saved by using exogeneous sources. Processing speed is increased by optimizing the models and/or processes used.

One or more aspects of the present disclosure may be integrated with artificial intelligence and/or applications (e.g., architecture applications and/or other applications) to detect risk-based events and patterns, identify problematic accounts and take appropriate action. Further, one or more aspects may be included and/or used in online platforms, mobile applications and/or messaging systems to detect risk-based event patterns and provide instructional guidance, thus enhancing the security of online activities. Newly reported risk-based events can be added into the system to generate new process flows. Other examples are possible.

The computing environments described herein are only examples of computing environments that can be used. One or more aspects of the present disclosure may be used with many types of environments. Each computing environment is capable of being configured to include and/or use one or more aspects of the present disclosure. For instance, each may be configured to predict and provide alerts for risk-based events and/or to perform one or more other aspects of the present disclosure.

In addition to the above, one or more aspects may be provided, offered, deployed, managed, serviced, etc. by a service manager who offers management of customer environments. For instance, the service manager can create, maintain, support, etc. computer code and/or a computer infrastructure that performs one or more aspects for one or more customers. In return, the service manager may receive payment from the customer under a subscription and/or fee agreement, as examples. Additionally, or alternatively, the service manager may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, other probability equations/formulas may be used. Further, additional, fewer and/or other models may be trained/retrained and used in the processing. A messaging tool may have additional, fewer and/or other components. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A method comprising:
executing a messaging tool on a computing device to conduct and analyze a real-time conversation between, at least, one user and another user, the messaging tool including at least one artificial intelligence model generated and integrated into the messaging tool, the at least one artificial intelligence model being generated based on analyzing historical data obtained from one or more exogenous sources, the historical data including, at least, data related to one or more historical risk-based events, the at least one artificial intelligence model trained to categorize analysis data resulting from the analyzing the historical data and to predict a risk-based event;
performing, using the messaging tool, real-time analysis of the real-time conversation to generate a probability score, the probability score indicating a prediction that the real-time conversation is the risk-based event; and
visualizing the risk-based event using the messaging tool to indicate to a selected user that the real-time conversation is the risk-based event, the selected user being a user of the one user and the another user of the real-time conversation.

2. The method of claim 1, wherein the at least one artificial intelligence model includes a category model trained to categorize the analysis data resulting from the analyzing the historical data and a prediction model trained to predict the risk-based event.

3. The method of claim 1, wherein the historical data is obtained from the one or more exogenous sources via at least one network coupled to the computing device executing the messaging tool.

4. The method of claim 1, wherein the historical data includes data selected from a group of data consisting of emails, text messages, chats, phone recordings, audio recordings and account information.

5. The method of claim 1, wherein the visualizing the risk-based event includes visualizing the risk-based event using a graphical user interface of the messaging tool.

6. The method of claim 1, further comprising:
analyzing the historical data relating to the one or more historical risk-based events; and
generating a category model based on the analyzing the historical data, the category model being one model of the at least one artificial intelligence model and wherein the category model includes a plurality of categories of the historical data generated based on keywords of the historical data.

7. The method of claim 6, further comprising generating one or more process flows based on the plurality of categories, wherein a process flow of the one or more process flows indicates a particular type of risk-based event.

8. The method of claim 7, wherein the performing the real-time analysis includes:
executing a prediction model to determine the probability score for the real-time conversation, the prediction model being another model of the at least one artificial intelligence model; and
executing the category model to select a process flow of the one or more process flows coinciding with the real-time analysis of the real-time conversation, based on the probability score indicating that the real-time conversation is the risk-based event.

9. The method of claim 8, wherein the probability score is generated based on a probability equation, and wherein the probability equation uses keywords and user information obtained from the real-time analysis of the real-time conversation.

10. The method of claim 8, wherein the visualizing includes depicting within the process flow a step of the process flow indicating the risk-based event.

11. A computer program product comprising:
a set of one or more computer-readable storage media; and
program instructions, collectively stored in the set of one or more computer-readable storage media, for causing at least one computing device to perform computer operations including:
executing a messaging tool on a computing device of the at least one computing device to conduct and analyze a real-time conversation between, at least, one user and another user, the messaging tool including at least one artificial intelligence model generated and integrated into the messaging tool, the at least one artificial intelligence model being generated based on analyzing historical data obtained from one or more exogenous sources, the historical data including, at least, data related to one or more historical risk-based events, the at least one artificial intelligence model trained to categorize analysis data resulting from the analyzing the historical data and to predict a risk-based event;
performing, using the messaging tool, real-time analysis of the real-time conversation to generate a probability score, the probability score indicating a prediction that the real-time conversation is the risk-based event; and
visualizing the risk-based event using the messaging tool to indicate to a selected user that the real-time conversation is the risk-based event, the selected user being a user of the one user and the another user of the real-time conversation.

12. The computer program product of claim 11, wherein the at least one artificial intelligence model includes a category model trained to categorize the analysis data resulting from the analyzing the historical data and a prediction model trained to predict the risk-based event.

13. The computer program product of claim 11, wherein the computer operations further comprise:
analyzing the historical data relating to the one or more historical risk-based events; and
generating a category model based on the analyzing the historical data, the category model being one model of the at least one artificial intelligence model and wherein the category model includes a plurality of categories of the historical data generated based on keywords of the historical data.

14. The computer program product of claim 13, wherein the computer operations further comprise generating one or more process flows based on the plurality of categories, wherein a process flow of the one or more process flows indicates a particular type of risk-based event.

15. The computer program product of claim 14, wherein the performing the real-time analysis includes:
executing a prediction model to conduct the real-time analysis of the real-time conversation to determine the probability score for the real-time conversation, the prediction model being another model of the at least one artificial intelligence model; and
executing the category model to select a process flow of the one or more process flows coinciding with the real-time analysis of the real-time conversation, based on the probability score indicating that the real-time conversation is the risk-based event.

16. A computer system comprising:
at least one computing device;
a set of one or more computer-readable storage media; and
program instructions, collectively stored in the set of one or more computer-readable storage media, for causing the at least one computing device to perform computer operations including:
executing a messaging tool on a computing device of the at least one computing device to conduct and analyze a real-time conversation between, at least, one user and another user, the messaging tool including at least one artificial intelligence model generated and integrated into the messaging tool, the at least one artificial intelligence model being generated based on analyzing historical data obtained from one or more exogenous sources, the historical data including, at least, data related to one or more historical risk-based events, the at least one artificial intelligence model trained to categorize analysis data resulting from the analyzing the historical data and to predict a risk-based event;
performing, using the messaging tool, real-time analysis of the real-time conversation to generate a probability score, the probability score indicating a prediction that the real-time conversation is the risk-based event; and
visualizing the risk-based event using the messaging tool to indicate to a selected user that the real-time conversation is the risk-based event, the selected user being a user of the one user and the another user of the real-time conversation.

17. The computer system of claim 16, wherein the at least one artificial intelligence model includes a category model trained to categorize the analysis data resulting from the analyzing the historical data and a prediction model trained to predict the risk-based event.

18. The computer system of claim 16, wherein the computer operations further comprise:
analyzing the historical data relating to the one or more historical risk-based events; and
generating a category model based on the analyzing the historical data, the category model being one model of the at least one artificial intelligence model and wherein the category model includes a plurality of categories of the historical data generated based on keywords of the historical data.

19. The computer system of claim 18, wherein the computer operations further comprise generating one or more process flows based on the plurality of categories, wherein a process flow of the one or more process flows indicates a particular type of risk-based event.

20. The computer system of claim 19, wherein the performing the real-time analysis includes:
executing a prediction model to conduct the real-time analysis of the real-time conversation to determine the probability score for the real-time conversation, the prediction model being another model of the at least one artificial intelligence model; and
executing the category model to select a process flow of the one or more process flows coinciding with the real-time analysis of the real-time conversation, based on the probability score indicating that the real-time conversation is the risk-based event.
